(19) United States
(12) Patent Application Publication
(10) Pub. No.: US 2015/0374010 A1
(43) Pub. Date: Dec. 31, 2015

(54) DRINK STIR, STRAW, LOLLIPOP STICK WITH FIGURINE AND METHOD OF MAKING THE SAME

(71) Applicant: Wenqian Feng, Lake Mary, FL (US)

(72) Inventor: Wenqian Feng, Lake Mary, FL (US)

(21) Appl. No.: 14/844,656

(22) Filed: Sep. 3, 2015

(51) Int. Cl. A23G 3/56; A63H 3/50; A47G 21/18

(52) U.S. Cl. CPC A23G 3/563; A47G 21/183; A47G 21/182; A63H 3/50; A23V 2002/00

(57) ABSTRACT

The embodiments herein provide an edible article housing a figurine comprising a figurine head, a figurine base and an edible layer. The figurine head is moulded in a predetermined shape. The figurine base is detachably attached to the figurine head. The edible layer is formulated over the figurine head. The edible layer belongs to a group of edible food products and flavours. The group of edible food product primarily comprises confectioneries. The figurine head and the figurine base are moulded into a predetermined shape. A molten form of the edible layer is poured into a mould and the figurine head is dipped into the poured molten edible layer. The molten edible layer gradually solidifies and the solidified edible layer form a confectionery layer over the figurine head.

### BACKGROUND

1. Technical Field of Invention

The embodiments herein generally relate to a straw with a 3D figurine at one of the end. The straw is alternatively used as a drink stir and a lollipop stick. The embodiments herein more particularly relate to a lollipop layered over a figurine and the figurine is of a plurality of shapes catering a plurality of entertainment article such as games and utility articles like finger rings.

2. Description of Related Art

The entertainment industry, toy industry and food industry are mingling a plurality of techniques now-a-days to increase a market coverage. But the amalgamation of food and toy industry have very limited approach towards marketing and product processing. The most fondly used technique is to suitably place a toy or a figurine inside a food packaging.

One of the prior arts discloses an edible toy figure comprising a torso member and a head member associated with said torso member and at least one limb member associated with said torso member such that said at least one limb member is posed relative to said torso member. The said torso member, said head member, and said at least one limb member are formed from a food-grade material.

Another prior art discloses a transformable toy including a first member, a second member and a third member. A first surface of the first member is a first part of an exterior surface of a substantially spherical structure in a first configuration. A second surface of the second member is a second part of the exterior surface of the substantially spherical structure in the first configuration. The first member and the second member are positionable in a second configuration in which at least a portion of the second member is further from at least a portion of the first member. The at least portion of the second member includes an edge which includes an arc-shaped portion. The first member, second member and third member are positionable in a third configuration.

The prior arts are formulating a figurine shaped edible article or creating an outer figuring to house the edible article. However, the prior arts are limited in formulating an edible article over a figurine in which the figurine can be a part of a piece in a game, a comic actor, a utility article or a surprise gift article.

In the view of foregoing, there is a need for an edible article housing a multi-facet or multi-shape figurine.

The above mentioned shortcomings, disadvantages and problems are addressed herein, as detailed below.

### SUMMARY OF THE INVENTION

The primary object of the embodiments herein is to provide an edible article housing a multi-facet or multi-shape figurine.

Another object of the embodiments herein is to formulate an edible article over a figurine in which the figurine can be a part of a piece in a game, a comic actor, a utility article or a surprise gift article.

The embodiments herein provide an edible article housing a figurine comprising a figurine head, a figurine base and an edible layer. The figurine head is moulded in a predetermined shape. The figurine base is detachably attached to the figurine head. The edible layer is formulated over the figurine head. The edible layer belongs to a group of edible food products and flavours. The group of edible food product primarily comprises confectioneries. The figurine head and the figurine base are moulded into a predetermined shape. A molten form of the edible layer is poured into a mould and the figurine head is dipped into the poured molten edible layer. The molten edible layer gradually solidifies and the solidified edible layer form a confectionery layer over the figurine head.

According to one embodiment herein, the figurine head is either detachable or permanently attached to the figurine head depending upon a usage.

According to one embodiment herein, the melting point of the figurine head and the figurine base is at-least 300° F.

According to one embodiment herein, the figurine base and the figurine head are hollow in nature.

According to one embodiment herein, the melting point of the figurine head and the figurine base is higher than the melting point of the edible layer.

According to one embodiment herein, the figurine base is placed on a base platform.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1a, 1b, 1c, 1d and 1e illustrates a front view, a side view, a rear view, a top view and a sectional view of the straw with an exemplary figurine moulded in a first format, according to an embodiment herein.

FIGS. 2a, 2b, 2c, 2d and 2e illustrates a front view, a side view, a rear view, a top view and a sectional view of the straw with an exemplary figurine moulded in a first format, according to an embodiment herein.

FIGS. 3a, 3b, 3c, 3d and 3e illustrates a front view, a side view, a rear view, a top view and a sectional view of the straw with an exemplary figurine moulded in a first format, according to an embodiment herein.

FIGS. 4a, 4b, 4c, 4d and 4e illustrates a front view, a side view, a rear view, a top view and a sectional view of the straw with an exemplary figurine moulded in a second format, according to an embodiment herein.

FIGS. 5a, 5b, 5c, 5d and 5e illustrates a front view, a side view, a rear view, a top view and a sectional view of the straw with an exemplary figurine moulded in a second format, according to an embodiment herein.

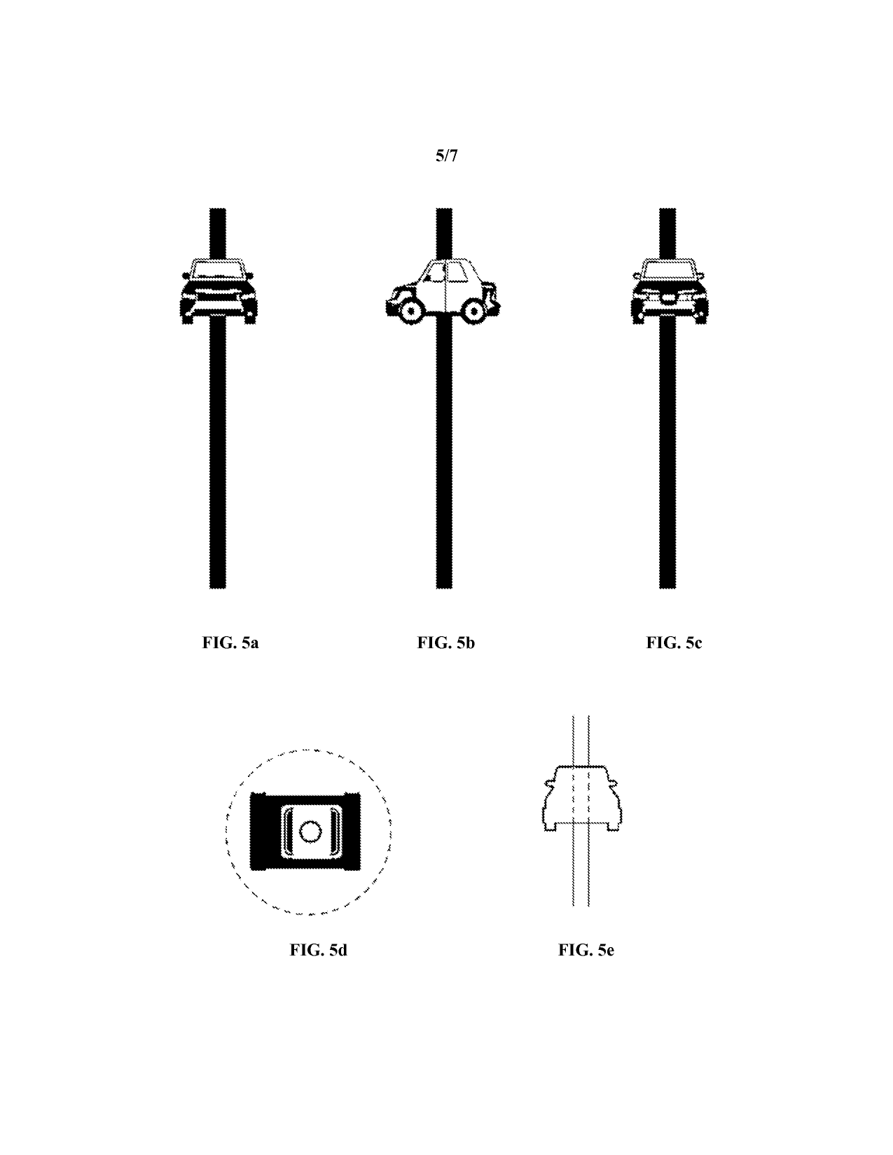

FIGS. 6a, 6b, 6c, 6d and 6e illustrates a front view, a side view, a rear view, a top view and a sectional view of the straw with an exemplary figurine moulded in a first format, according to an embodiment herein.

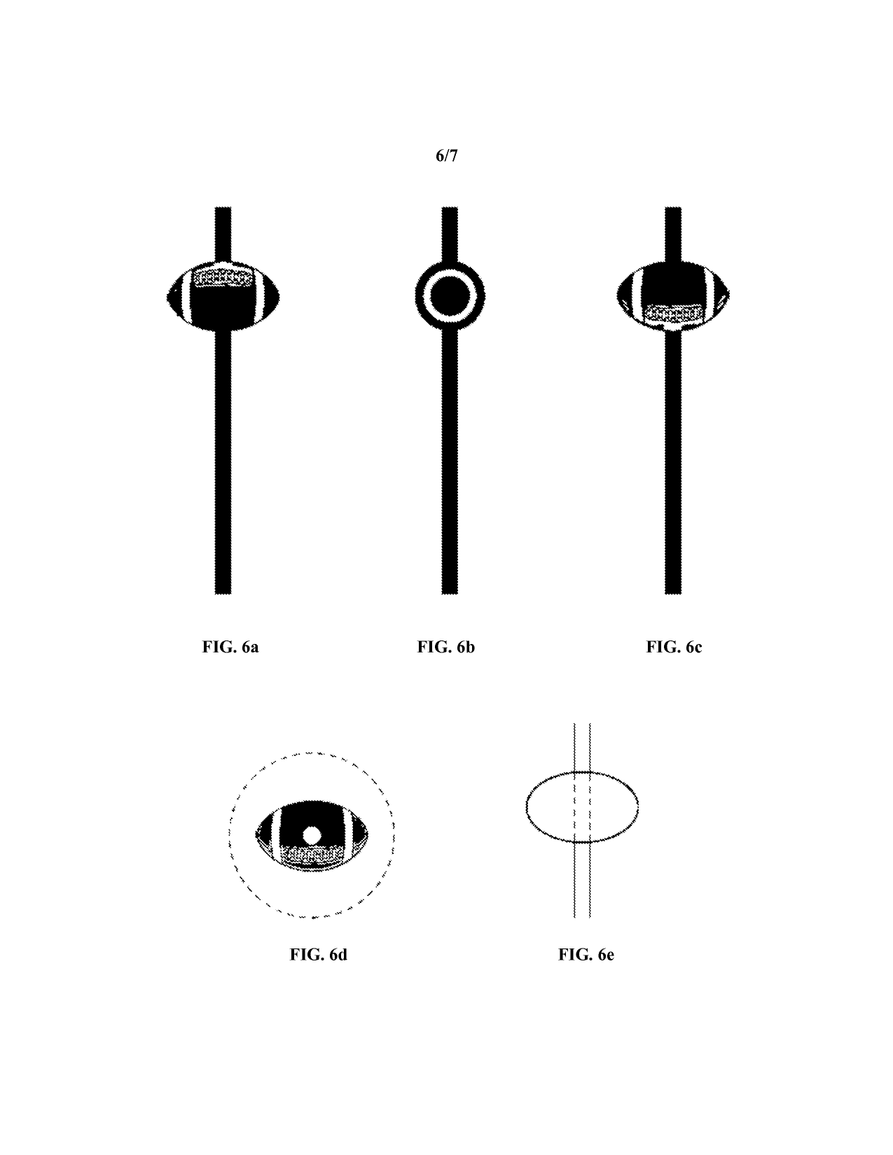

FIG. 7 illustrates a sectional view of the straw with an exemplary figurine and a usage of the same, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide an edible article housing a figurine comprising a figurine head, a figurine base and an edible layer. The figurine head is moulded in a predetermined shape. The figurine base is detachably attached to the figurine head. The edible layer is formulated over the figurine head. The edible layer belongs to a group of edible food products and flavours. The group of edible food product primarily comprises confectioneries. The figurine head and the figurine base are moulded into a predetermined shape. A molten form of the edible layer is poured into a mould and the figurine head is dipped into the poured molten edible layer. The molten edible layer gradually solidifies and the solidified edible layer form a confectionery layer over the figurine head.

According to one embodiment herein, the figurine head is either detachable or permanently attached to the figurine head depending upon a usage.

According to one embodiment herein, the melting point of the figurine head and the figurine base is at-least 300° F.

According to one embodiment herein, the figurine base and the figurine head are hollow in nature.

According to one embodiment herein, the melting point of the figurine head and the figurine base is higher than the melting point of the edible layer.

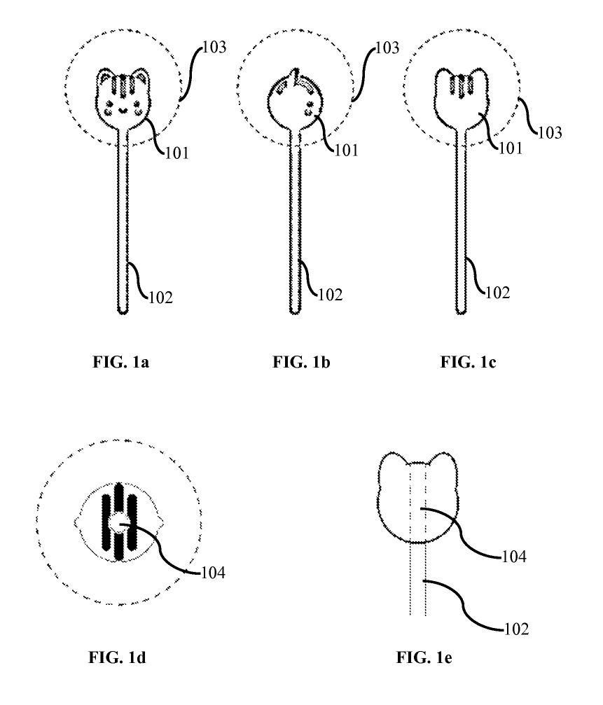

According to one embodiment herein, the figurine base is placed on a base platform. Also the figurine base is primarily in a form of a stick that is hollow in nature and alternatively used as a drink stirrer like a coffee, a cocktail and other drinks. The figurine base is also used as a straw due to a hollow structure. The figurine base also assists in identifying individual drinks in a party or a conference or a gathering place. [0032] FIG. 1a-1e illustrates a front view, a side view, a rear view, a top view and a sectional view of the straw with an exemplary figurine moulded in a first format, according to an embodiment herein. With respect to FIG. 1a, 1b and 1c, the edible article housing a figurine comprising a figurine head 101, a figurine base 102 and an edible layer 103. The figurine head 101 is moulded in a predetermined shape. The figurine base 102 is detachably attached to the figurine head 101. The edible layer 103 is formulated over the figurine head 101. The edible layer 103 belongs to a group of edible food products and flavours. The group of edible food product primarily comprises confectioneries. The figurine head 101 and the figurine base (straw) 102 are moulded into a predetermined shape. A molten form of the edible layer 103 is poured into a mould and the figurine head 101 is dipped into the poured molten edible layer. The molten edible layer gradually solidifies and the solidified edible layer 103 form a confectionery layer over the figurine head 101. The figurine head 101 is formulated into a shape of a comic character or a human character or an animal or a Chinese zodiac or a Pandora charm. With respect to FIGS. 1d and 1e, the figurine base 102 is passed through a circular passage 104 of the figurine head 101 upto a top end of the figurine head 101 in such a way that no portion of the figurine base (straw) 102 lies above the figurine head 101.

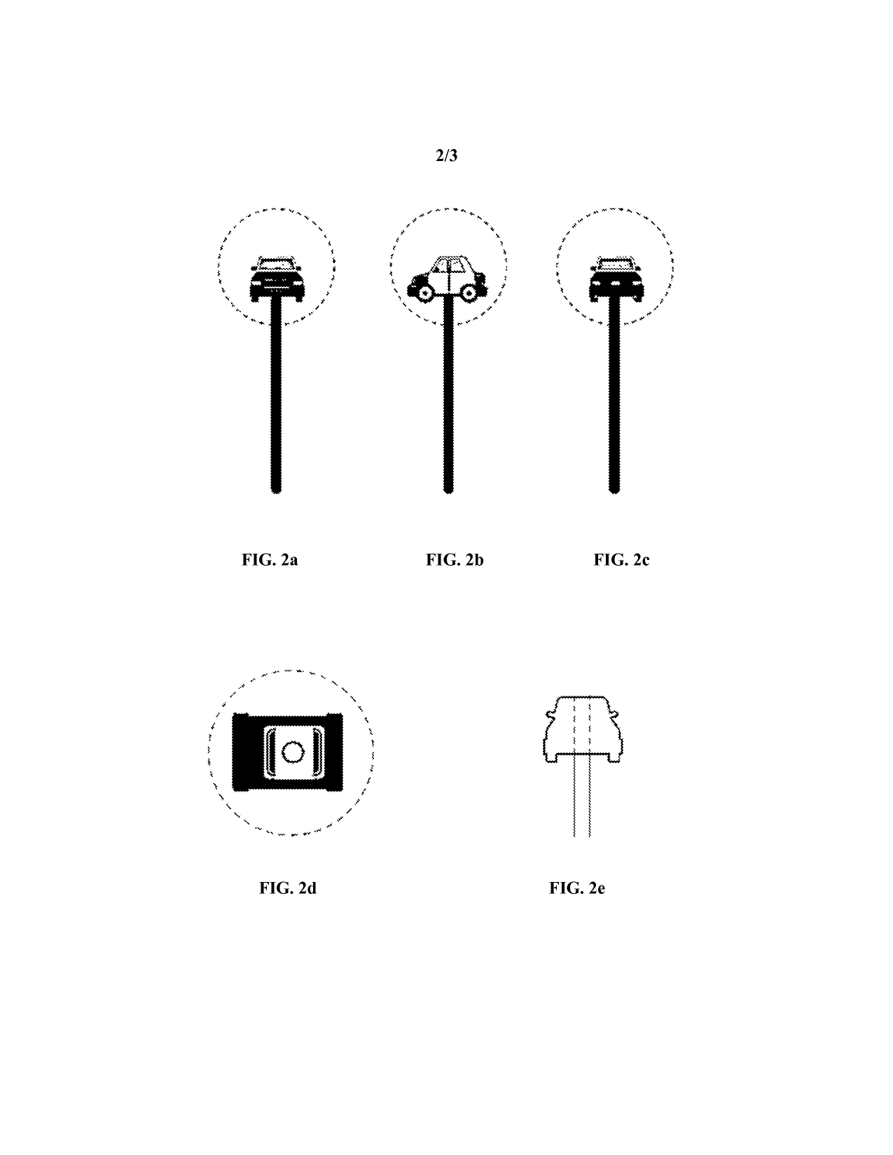

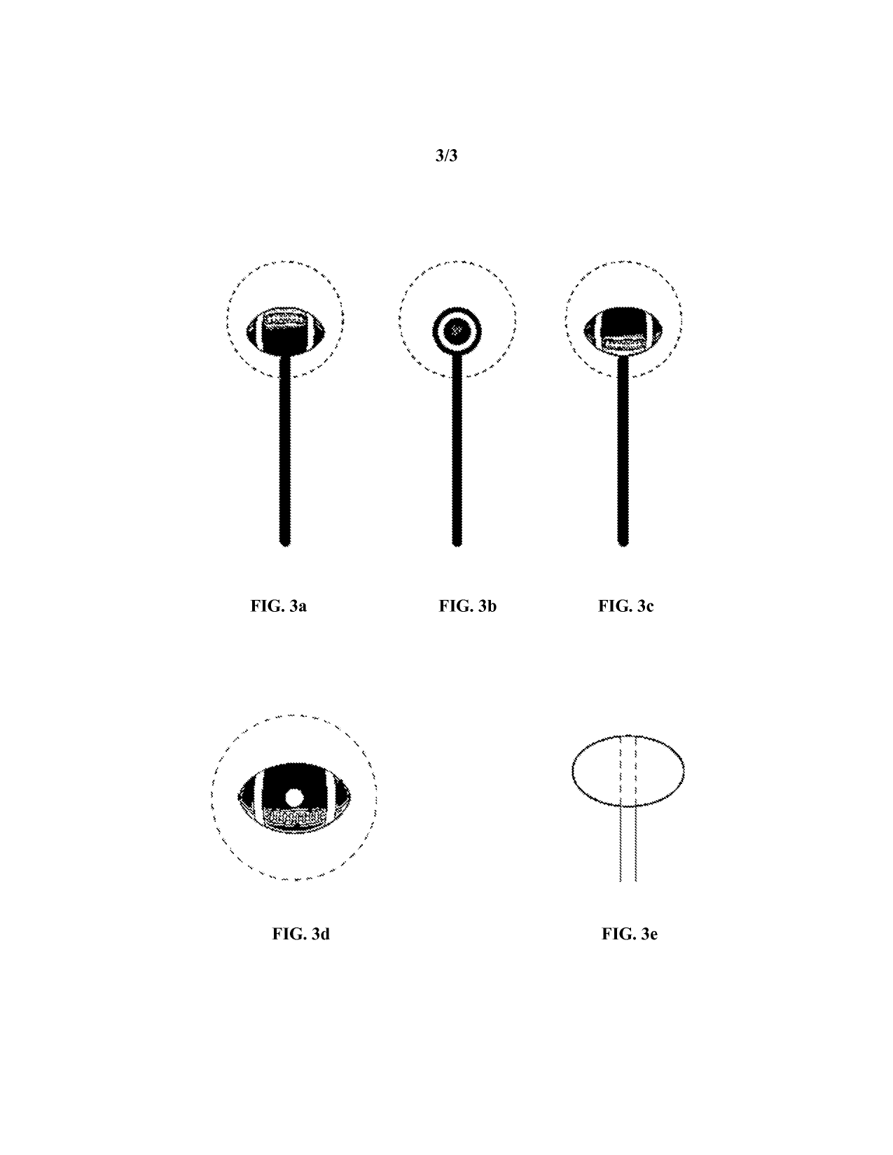

FIG. 2a-2e illustrates a front view, a side view, a rear view, a top view and a sectional view of the straw with an exemplary figurine moulded in a first format, according to an embodiment herein. FIG. 3a-3e illustrates a front view, a side view, a rear view, a top view and a sectional view of the straw with an exemplary figurine moulded in a first format, according to an embodiment herein. With respect to FIGS. 2a, 2b and 2c, the figurine head is formulated into a shape of a car. With respect to FIGS. 3a, 3b and 3c, the figurine head is formulated in the form of a rugby ball. The figurine head is formulated into a shape of any man made article like a wedding ring or a transportation vehicle or a sports article. With respect to FIGS. 2d, 2e, 3d and 3e, the figurine base 102 is passed through a circular passage 104 of the figurine head 101 upto a top end of the figurine head 101 in such a way that no portion of the figurine base (straw) 102 lies above the figurine head 101.

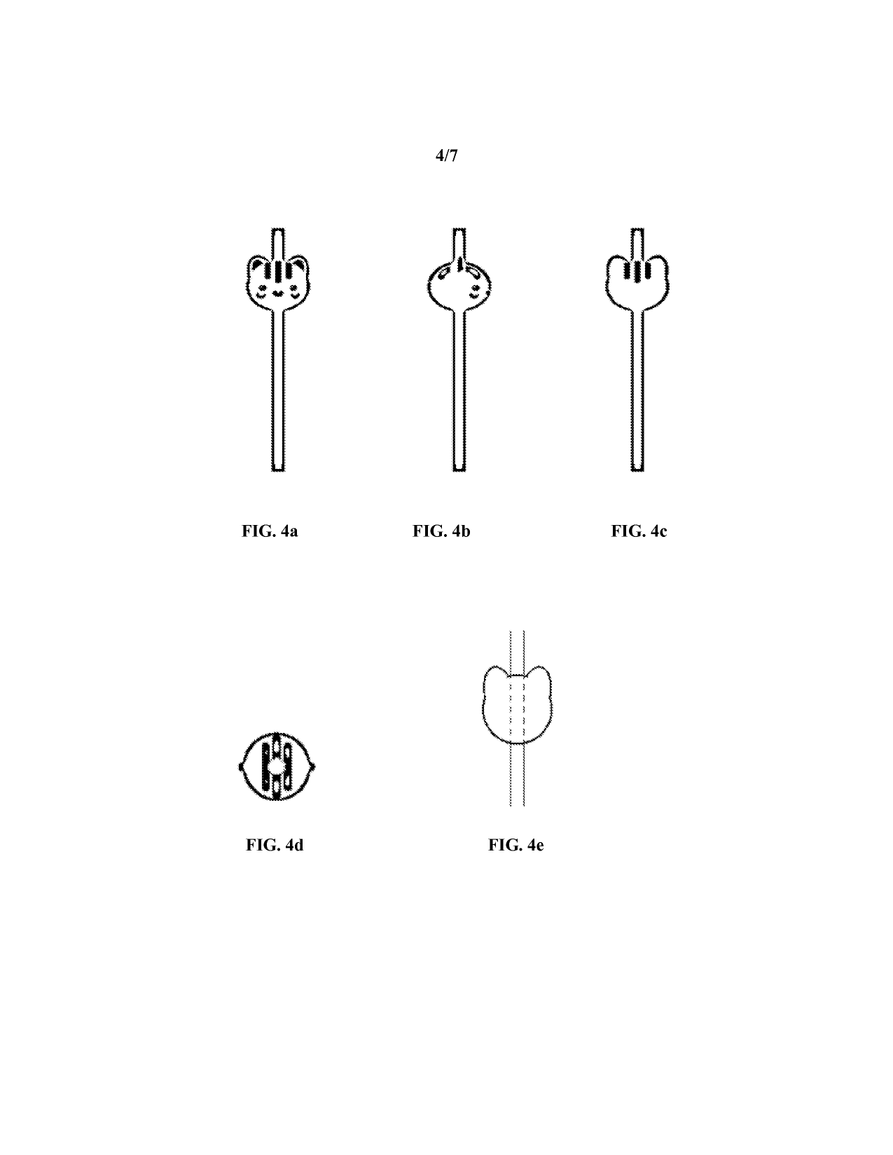

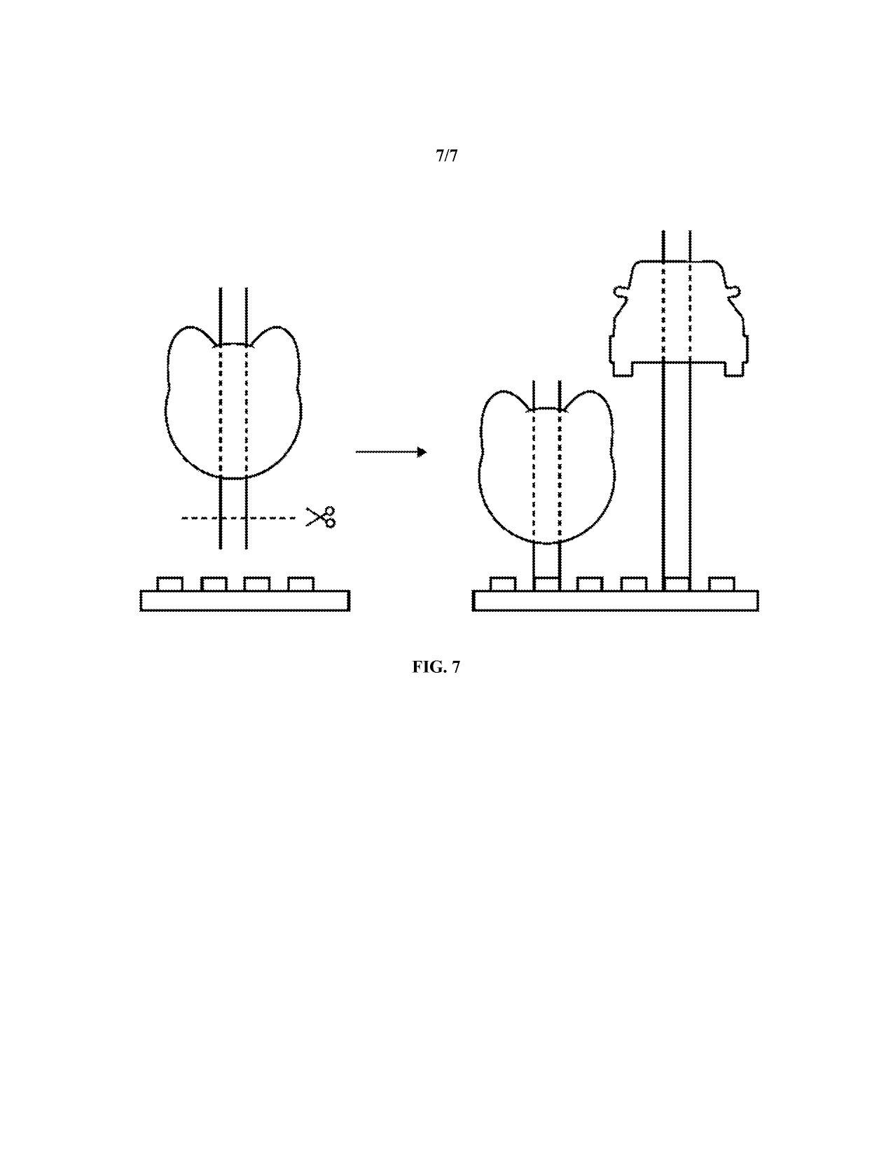

FIG. 4a-4e, 5a-5e and 6a-6e illustrates a front view, a side view, a rear view, a top view and a sectional view of the straw with an exemplary figurine moulded in a second format, according to an embodiment herein. With respect to FIG. 4a-4e, 5a-5e and 6a-6e, the figurine base (straw) 102 is passed through a circular passage 104 in the figurine head 101 in such a way that a minor portion of the straw 102 resides above the figurine head 101 while a major portion of the figurine base 102 resides below the figurine head 101. [0035] FIG. 7 illustrates a sectional view of the straw with an exemplary figurine and a usage of the same, according to an embodiment herein. With respect to FIG. 7, the figurine head forms a souvenir or a collectible and also becomes a part of a board game character. The figurine base is cut through its length resulting in a shortened height of the figurine base alongwith the figurine head. The figurine base (straw) is then fixed over a board or used for a playing games like chess.

According to an exemplary embodiment herein, the edible article with figurine head also serves as a gift item and an article to be used as a surprise element such as a wedding ring housed within a selectively open-able plastic casing housed within the layer of the edible article.

The edible article with figurine head provides a plurality of article to be of playing purpose or collecting or showcase purpose. The edible article with figurine head caters less sugar consumption but high volume product sales as it provides a vivid range of post-consumption articles.

The present invention is exclusively used as a drink stirrer or straw and allows an identification of a user's drink as his or her drink is served with a unique and distinct stirrer.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. An edible article housing a figurine comprising:
a figurine head, wherein the figurine head is moulded in a predetermined shape;
a figurine base, wherein the figurine base is detachably attached to the figurine head;
an edible layer, wherein the edible layer is formulated over the figurine head, wherein the edible layer belongs to a group of edible food products and flavours, wherein the group of edible food product primarily comprises confectioneries;
wherein, the figurine head and the figurine base are moulded into a predetermined shape,
wherein a molten form of the edible layer is poured into a mould, wherein the figurine head is dipped into the poured molten edible layer, wherein the molten edible layer gradually solidifies and the solidified edible layer forms a confectionery layer over the figurine head.

2. The edible article according to claim 1, wherein the melting point of the figurine head and the figurine base is at-least 300° F.

3. The edible article according to claim 1, wherein the figurine base and the figurine head are hollow in nature.

4. The edible article according to claim 1, wherein the melting point of the figurine head and the figurine base is higher than the melting point of the edible layer.

5. The edible article according to claim 1, wherein the figurine base is placed on a base platform.
